(19) United States
(12) Patent Application Publication
(10) Pub. No.: US 2026/0110767 A1
(43) Pub. Date: Apr. 23, 2026

(54) TRAJECTORY DETERMINING DEVICE

(71) Applicant: INTERSEC, Paris La Défense Cedex (FR)

(72) Inventors: Pierre-Louis CUNY, Paris La Défense Cedex (FR); Jean-Marc COÏC, Paris La Défense Cedex (FR); Mouna RHALIMI, Paris La Défense Cedex (FR)

(73) Assignee: INTERSEC, Paris La Défense Cedex (FR)

(21) Appl. No.: 19/158,755

(22) PCT Filed: Feb. 20, 2023
(86) PCT No.: PCT/FR2024/050221

§ 371 Date: Aug. 21, 2025

(30) Foreign Application Priority Data
Feb. 24, 2023 (FR) 2301708

(51) Int. Cl. G01S 5/02; G01S 11/08; H04W 4/02

(52) U.S. Cl. CPC G01S 5/0294; G01S 11/08; H04W 4/027; G01S 2205/09

(57) ABSTRACT

A device for determining a trajectory receives mobile or wireless network signalling events each comprising a mobile communication device identifier, a timestamp, and a signalling identifier associated with a location and a location radius, preprocesses the associated signalling events to identify one or more long stationary state groups, trajectory segments and long stationary state segments, smooths events at the boundaries of long stationary state segments, processes them to associate each segment with a label belonging to a group comprising a movement and a stop, returns the long stationary state segments and the trajectory segments as trajectory data.

The invention relates to the field of trajectory detection, more particularly passively, from signalling events associated with a mobile device.

Determining the flow of people moving between different locations is complex. For a given location, it is possible to determine flows statistically, by measuring humanly the number of people entering and exiting. However, these methods are unreliable, have a high cost, and are lacking in contextual information. Indeed, it is not possible to know the point of origin of the people counted, the means of transport used, etc.

The Applicant has already invented several devices for determining trajectory data from signalling events associated with a mobile device. Thus, the European patent published under number EP 3 329 696 describes the definition of stop or movement type labels at pairs of consecutive signalling events over time, and the processing of these labels in order to establish trajectory data. The patent application published under number EP 3 586 319 describes an enhancement of this patent making it possible to determine a mode of transport associated with trajectory data.

The Applicant has also studied scientific articles. Among these, the article by Calabrese et al. “Estimating origin-destination flows using mobile phone location data”, IEEE Pervasive Computing (Volume: 10, Issue: 4, April 2011) describes the use of mobile phone data and defines, among a series of locations, stops as consisting of sets of locations for which the distances between two points are less than a given threshold, typically one kilometre. This approach is simplistic and does not address the problem of antenna hopping, i.e. successive attachment to different antennas that are potentially very far apart, while there is little or no actual movement.

The article by Leontiadis et al., “From cells to streets: Estimating mobile paths with cellular-side data”, CoNEXT 2014—Proceedings of the 2014 Conference on Emerging Networking Experiments and Technologies, 121-132, uses a time threshold to classify a stationary state, but in an approach where the distance threshold is “replaced” by intersection considerations between the coverage of a antenna and a cell of a grid segmenting the locality, locations on antennas being considered “close” if their coverages overlap the same cell of this grid. Here again, antenna hopping is not handled optimally.

The article by Ishizuka et al., “Traffic Analysis of Railway using Call Detail Records”, accessible at the address http://web.archive.org/web/20220125110421/https://netmob.org/www17/assets/img/boo kofabstract_oral_2017.pdf, notes that the approaches described above have the shortcoming of having to define thresholds that are sometimes arbitrary, substantially impacting results. Thus, a very high distance threshold will detect large movements correctly (“wide vision”), but will miss small movements within the stops generated, whereas a low threshold (“precise vision”) will detect these movements but will create noise due to telecom antenna hopping. The authors envisage in order to compensate for an approach combining the results of two applied distance thresholds, precise vision adjusting large paths detected by wide vision. This article, although less simplistic than the two previous ones, is not, however, satisfactory in practice, as the inter-antenna distances associated with telecom antenna hopping can vary greatly.

Finally, the article by Xu et al. “Effects of Data Preprocessing Methods on Addressing Location Uncertainty in Mobile Signalling Data”, Annals of the American Association of Geographers, 111:2, 515-539, discusses methodologies for reducing inherent mobile data noise, particularly when connecting to remote antennas in a very short time with rapid return to an antenna to which the mobile was previously connected. These methodologies are nonetheless dependent on the concept of reappearance on the same antenna, which is of course not always the case.

These devices and articles, although interesting, offer substantial scope for improvement, in particular to take better account of the relative durations separating the various events.

The Invention improves the situation. to this end, it proposes a device for determining a trajectory comprising:
a memory (4) arranged to receive mobile or wireless telephone network signalling events each comprising a mobile communication device identifier, a timestamp and a signalling identifier associated with a location and with a location radius,
a preprocessing unit arranged, for a given mobile communication device identifier, to run through the associated signalling events, and to identify one or more long stationary state groups comprising signalling events such that, within a given long stationary state group, the timestamps are consecutive and define a range whose duration is greater than a first threshold duration, and the locations have between them a distance less than a first threshold distance based on one or more of the location radii, the preprocessing unit being arranged to define a long stationary state segment from each long stationary state group, each long stationary state segment comprising, on one hand, boundaries corresponding to the end timestamps of the long stationary state group from which it originates and, on the other, a location determined from the locations of the signalling events of the long stationary state group from which it originates, and being associated with a stop type label,
a processing unit, arranged to process the signalling events whose timestamps are located outside a long stationary state segment by pair of signalling events having immediately consecutive timestamps that define the boundaries of a trajectory segment, comprising a smoother arranged to run through the signalling events, for which timestamps are located outside a long stationary state group first by ascending or descending timestamps, then by descending or ascending timestamps, to define during these two runs, for each current signalling event, a time window for which one end corresponds to said current signalling event, and the other end is a signalling event chosen in the ascending or descending run direction and for which the timestamp defines with the timestamp of the current signalling event a duration substantially equal to a second threshold duration, and to associate with each window a label belonging to a group comprising a movement and a stop, according to the distance between the locations of the signalling events defining its boundaries, a concentrator arranged, once the smoother has processed all of the signalling events whose timestamps are located outside a stationary state group have been run through by ascending and descending timestamps, to associate each trajectory segment with a label determined according to the labels of the time windows overlapping the boundaries of this trajectory segment, and
a post-processing unit arranged to:
first run through the trajectory segments associated with a movement type label, and change the label of some of these trajectory segments when the duration between its boundaries is less than a third threshold duration,
then run through the trajectory segments associated with a stop type label, and change the label of some of these trajectory segments when the duration between its boundaries is less than a fourth threshold duration,
determine for each trajectory segment associated with a stop type label a location determined from the locations of the signalling events whose timestamps are between the timestamps of its boundaries, and
return the long stationary state segments and the trajectory segments as trajectory data. This device is particularly advantageous because it makes it possible to determine more relevant trajectory data than with known methods. Indeed, thanks to the smoothing provided, telecom antenna hopping management is greatly improved, and the trajectory data is much more faithful to reality than in prior art solutions.

According to various embodiments, the invention may have one or more of the following features:
the processing unit is arranged, before applying the smoother,
to associate, with each trajectory segment for which the locations of its component signalling events have between them a distance which exceeds a second threshold distance and which, relative to the duration between the timestamps of said component signalling events, is less than a first threshold speed, a stop-movement type label,
to associate, with each trajectory segment for which the locations of its component signalling events have between them a distance which is less than a third threshold distance, a stop type label, and
to exclude from processing by the smoother the signalling events whose timestamp is within a trajectory segment associated with a stop-movement type or stop type label,
the post-processing unit is arranged, after running through the trajectory segments associated with a movement type label, and before running through the trajectory segments associated with a stop type label, to run through the trajectory segments associated with a stop-movement type label, and, for such a given trajectory segment, if the given trajectory segment is surrounded by two trajectory segments, one of which is associated with a stop type label and the other with a movement type label, to determine a distribution timestamp among the timestamps of the signalling events whose timestamps are between the timestamps of its boundaries according to the speed observed on the events of the segment associated with a movement type label that are closest to the given trajectory segment, and to redefine, on one hand, the trajectory segment associated with a stop type label so that it incorporates the events of the given trajectory segment whose timestamps are closest to it up to the distribution timestamp and, on the other, the trajectory segment associated with a movement type label so that it incorporates the events of the given trajectory segment for which the timestamps are closest to it up to the distribution timestamp,
the post-processing unit is arranged, after running through the trajectory segments associated with a stop type label, to run through the trajectory segments associated with a stop-movement type label, and to associate a stop type label or a movement type label with them,
the post-processing unit is arranged, during the run through the trajectory segments associated with a movement type label, to change the label of a trajectory segment whose duration between its boundaries is less than a third threshold duration into a stop type label when an immediately adjacent trajectory segment is associated with a stop type label, and into a presence type label otherwise, and
the post-processing unit is arranged, during the run through the trajectory segments associated with a stop type label, to change the label of a trajectory segment whose duration between its boundaries is less than a fifth threshold duration to a movement type label when an immediately adjacent trajectory segment is associated with a movement type label, and to a presence type label otherwise.

The invention also relates to a method for determining a trajectory comprising the following operations:
a) receiving mobile or wireless telephone network signalling events each comprising a mobile communication device identifier, a timestamp and a signalling identifier associated with a location and with a location radius,
b) for a given mobile communication device identifier, running through the associated signalling events, and identifying one or more long stationary state groups comprising signalling events such that, within a given long stationary state group, the timestamps are consecutive and define a range whose duration is greater than a first threshold duration, and the locations have between them a distance less than a first threshold distance taken from one or more of the location radii,
c) defining a long stationary state segment from each long stationary state group, each long stationary state segment comprising on one hand the boundaries corresponding to the end timestamps of the long stationary state group from which it originates and on the other a location determined from the locations of the signalling events of the long stationary state group from which it originates, and being associated with a stop type label,
d) processing the signalling events whose timestamps are located outside a long stationary state segment by pair of signalling events having immediately consecutive timestamps that define the boundaries of a trajectory segment,
e) running through the signalling events whose timestamps are located outside a long stationary state group first by ascending or descending timestamps, then by descending or ascending timestamps, to define during these two runs, for each current signalling event, a time window of which one end corresponds to said current signalling event, and the other end is a signalling event chosen in the ascending or descending run direction and for which the timestamp defines with the timestamp of the current signalling event a duration substantially equal to a second threshold duration, and to associate with each window a label belonging to a group comprising a movement and a stop, according to the distance between the locations of the signalling events defining its boundaries,
f) after operation e) has processed all of the signalling events whose timestamps are located outside a stationary state group have been run through by ascending and descending timestamps, to associate each trajectory segment with a label determined according to the labels of the time windows which overlap the boundaries of this trajectory segment, and
gl) first running through the trajectory segments associated with a movement type label, and changing the label of some of at least these trajectory segments when the duration between its boundaries is less than a third threshold duration,
g2) then running through the trajectory segments associated with a stop type label, and changing the label of some of at least these trajectory segments when the duration between its boundaries is less than a fourth threshold duration,
g3) determining for each trajectory segment associated with a stop type label a location determined from the locations of the signalling events whose timestamps are between the timestamps of its boundaries, and
g4) returning the long stationary state segments and the trajectory segments as trajectory data.

According to various embodiments, the method may have one or more of the following features:
operation e) comprises the following preliminary operations:
e1) associating, with each trajectory segment for which the locations of its component signalling events have between them a distance which exceeds a second threshold distance and which, relative to the duration between the timestamps of said component signalling events, is less than a first threshold speed, a stop-movement type label,
e2) associating, with each trajectory segment for which the locations of its component signalling events have between them a distance which is less than a third threshold distance, a stop type label, and
e3) excluding from the processing of operation e) the signalling events whose timestamp is within a trajectory segment associated with a stop-movement type label or a stop type label,
after operation g1) and before operation g2, g1a) running through the trajectory segments associated with a stop type label, and, for such a given trajectory segment, if the given trajectory segment is surrounded by two trajectory segments, one of which is associated with a stop type label and the other with a movement type label, determining a distribution timestamp among the timestamps of the signalling events whose timestamps are between the timestamps of its boundaries according to the speed observed on the events of the segment associated with a movement type label that are closest to the given trajectory segment, and redefining, on one hand, the trajectory segment associated with a stop type label so that it incorporates the events of the given trajectory segment for which the timestamps are closest to it up to the distribution timestamp and, on the other, the trajectory segment associated with a movement type label so that it incorporates the events of the given trajectory segment for which the timestamps are closest to it up to the distribution timestamp,
after operation g2), g2a) running through the trajectory segments associated with a stop-movement type label, and associating them with a stop type label or a movement type label,
operation g1) comprises changing the label of a trajectory segment whose duration between its boundaries is less than a third threshold duration into a stop type label when an immediately adjacent trajectory segment is associated with a stop type label, and into a presence type label otherwise, and
operation g2) comprises changing the label of a trajectory segment whose duration between its boundaries is less than a fifth threshold duration into a movement type label when an immediately adjacent trajectory segment is associated with a movement type label, and into a presence type label otherwise.

The invention also relates to a computer program comprising instructions for executing the method according to the invention, a data storage medium on which such a computer program is recorded and a computer system comprising a processor coupled to a memory, the memory having recorded such a computer program.

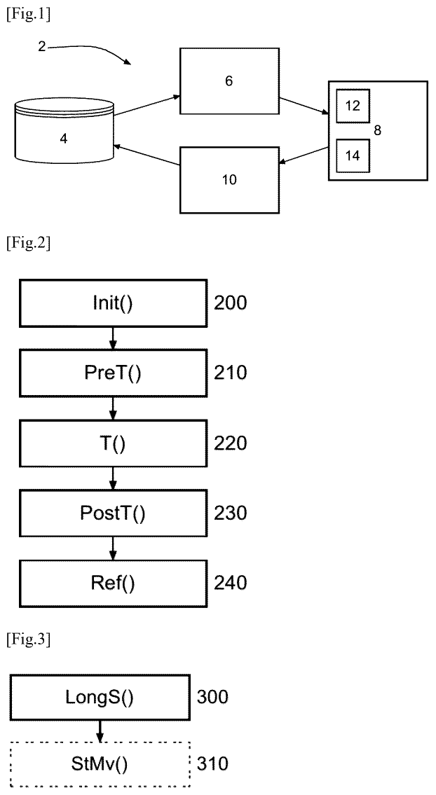

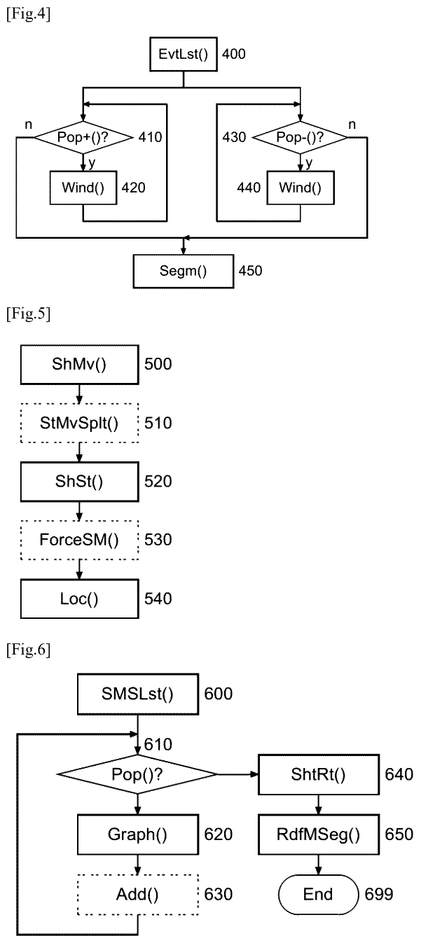

Other features and advantages of the invention will become more apparent upon reading the following description, with reference to examples given for illustrative and non-limiting purposes, with reference to the drawings wherein:
FIG. 1 shows a schematic diagram of a device according to the invention,
FIG. 2 shows an exemplary implementation of an operating loop of the device of FIG. 1,
FIG. 3 shows an exemplary implementation of a function of an operation of FIG. 2,
FIG. 4 shows an exemplary implementation of a function of an operation of FIG. 2,
FIG. 5 shows an exemplary implementation of a function of an operation of FIG. 2, and
FIG. 6 shows an exemplary implementation of a function of an operation of FIG. 2.

The drawings and the description below contain, for the most part, elements of a certain nature. Hence, they can not only serve to better understand the present invention, but also contribute to the definition thereof, where appropriate.

The present description is of such a nature as to involve elements capable of protection by copyright. The holder of the rights has no objection to identical reproduction by anyone of the present patent document or of the description thereof, as it appears in the official dossiers. For the remainder, it fully reserve its rights.

FIG. 1 shows a schematic diagram of a device 2 according to the invention. The device 2 comprises a memory 4, a preprocessing unit 6, a processing unit 8 and a post-processing unit 10. The processing unit comprises a smoother 12 and a compactor 14.

As mentioned in the introduction, the field of the invention relates to determining trajectory data from data passively generated by devices such as mobile phones. It consists of any data linked to signalling and attachment to wireless communication antennas, whether they are radiotelephone (cellular) or Wi-Fi type.

Geolocation data sources, particularly in cellular networks, are such that the frequency of these locations can be very variable, with sometimes several locations in a few seconds, before a long period (several tens of minutes or even several hours) without any new location. The prior art does not address this point or how the algorithms envisaged should be adapted to these different scenarios. In particular, there is no provision for the option of a segmentation into break and movement periods that take place over a time when no location is provided.

The data used within the scope of the invention is stored in the memory 4. This data mainly relates to what will be described hereinafter as signalling events. The signalling events each comprise a mobile communication device identifier, a timestamp, and a signalling identifier associated with a location and with a location radius. Thus, the mobile communication device identifier is the identifier used on the network concerned (IMSI in cellular, Mac in Wi-Fi, etc.), the timestamp is the time of the event in question, and the signalling identifier is the cell or antenna concerned by this event. Thus, the signalling identifier denotes a location, i.e. the centre of the cell or the known location of the antenna, and a location radius, which corresponds to the coverage zone of the cell or of the antenna. Although the term radius is used here, coverage is generally not circular, but rather corresponds to an arc of a circle.

These locations are potentially obtained from a mobile phone operator, who may have access to a “precise” location in their locality, and only know the roaming country if one of their subscribers travels abroad, i.e. cannot locate them in the country of destination. In this roaming scenario, the selected location can be based on unique coordinates for the country of destination, located in the country's barycentre.

Optionally, the service provider's antenna repository-the list of antennas with their respective coordinates-can also be used in the case of cellular data, or another source providing the distribution of the population of the country in question. This type of source allows us to estimate a “characteristic inter-antenna distance” locally in a cellular network, either directly if the service provider's information is available, or by estimating it by population density, via the strong correlation existing between antenna density on one hand and population density on the other. It is this distance that will allow us to obtain precision in our determination of stationary state or movement that automatically adapts to the zone in question.

Based on the signalling events, the device 2 performs various computations and classifications in order to assign labels to time segments. Indeed, two signalling events define a time segment by their respective timestamps. This time segment (hereinafter segment) can be used to qualify a trajectory status. For example, it is possible to attach a “stop” type label, which means that a given mobile device is considered as not having moved from a location that is associated with the segment.

The aim of the invention is that of producing trajectory data comprising, for a given mobile communication device identifier, a series of segments, each having two timestamps as time boundaries, a location in the case of a stop, and a label that qualifies the trajectory associated with this segment. Within the scope of the invention, six types of labels are envisaged: absent, off, stop, movement, stop-movement and presence. As will be seen hereinafter, the last two label types are optional.

The absent label and the off label are quite similar and mean the absence of signalling events for a defined duration. These labels are used to perform a temporal pre-segmentation of the signalling events associated with a mobile communication device as will become apparent hereinafter. The absent label and the movement label are known from the Applicant's patent FR 3 039 737 A1 and respectively denote a stop, i.e. a position considered as stationary, or a movement, i.e. travel.

As will be seen hereinafter, their definition has however evolved. Indeed, in the Applicant's previous applications, signalling events were run through to predefine stop or movement segments, then the segments were processed by deletion or grouping or conversion according to a chosen order. Within the scope of the invention, it is the processing unit that associates these labels with each segment, according to a method aimed at reducing antenna hopping.

The stop-movement label denotes a scenario where the mobile communication device has manifestly moved between two successive locations, but at an average speed that is too slow to be considered as having occurred over the entire period.

Finally, the presence label indicates that the mobile communication device is located in a given zone, without it being possible to define whether it is moving or stationary, as when a single location is reported over the entire period in question.

These last two labels are optional, and can either be returned with the trajectory data to provide enhanced trajectory data, or be reduced to a stop or movement label as will be seen hereinafter.

In the following, a segment may be identified by its label, i.e. a stop segment means a segment that has a stop type label. Similarly, segments can be grouped according to their respective labels, i.e. movement segments will denote all segments with a movement type label.

The memory 4 can be any data storage type capable of receiving digital data: hard drive, solid-state drive, flash memory in any form, random-access memory, magnetic disk, locally distributed or cloud storage, etc.

In the example described here, the memory 4 receives all of the data relating to the device 2, i.e. the programs and software instantiating the preprocessing unit 6, the processing unit 8 and the post-processing unit 10, their parameters and hyperparameters, the weights of the neural networks, the outputs and intermediate data of the neural networks, the data of the signalling events received as an input (where applicable), the intermediate values generated, data stored in buffer memory, and also output trajectory data. The data computed by the device can be stored on any type of memory similar to the memory 4, or on the latter. This data can be erased after the device has performed its tasks, or stored. The preprocessing unit 6, the processing unit 8 (including the smoother 12 and the compactor 14) and the post-processing unit 10 access the memory 4 directly or indirectly. They could be made in the form of an appropriate computer code executed on one or more processor(s). By processors, it should be understood any processor suited to the computations described hereinbelow. Such a processor may be made in any known manner, in the form of a microprocessor for a personal computer, laptop, tablet or smartphone, an FPGA or SoC type dedicated chip, a computing resource on a grid or in the cloud, a cluster of graphical processors (GPUs), a microcontroller, or any other form capable of providing the computing power necessary to the completion of the process described hereinbelow. One or more of these elements may also be made in the form of specialised electronic circuits such as an ASIC. A combination of a processor and of electronic circuits may also be contemplated. Machine-learning dedicated processors could also be contemplated.

Furthermore, it will become apparent that the segmentation of the device 2 into three functional units reproduces the flow of processing of events thereby. This segmentation is nevertheless not fixed: the preprocessing unit 6, the processing unit 8 and the post-processing unit 10 may be partially or fully merged, or even separated into a more refined unit as shown with the smoother 12 and the compactor 14.

FIG. 2 shows a schematic exemplary implementation of the device 2. This loop starts in an operation 200 by the execution of a function Init() by the preprocessing unit 6. In this operation, the preprocessing unit 6 receives the signalling events and prepares them for processing. For this purpose, if the signalling events are associated with distinct mobile communication device identifiers, they are separated and grouped according to the latter. Furthermore, because the signalling events are mainly processed based on their temporality, the function Init() can assemble them by ascending or descending timestamps, in order to accelerate subsequent processing. Once the signalling events have been grouped by mobile communication device identifier and arranged temporally, the function Init() can run through them to determine the segments for which the label is absent or off type. As explained above, these labels correspond respectively to the absence of a signalling event for a duration exceeding a given threshold, for example of the order of two hours or more, and to the presence of a signalling event indicating that the cellular signal is off (either because the device is off or because the cellular connection is intentionally switched off), for a duration exceeding a threshold, for example of more than 5 minutes.

These first segments are important, because they define a first temporal segmentation of the signalling events. Thus, in the following operations, not all of the signalling events are considered, but the signalling events whose timestamps are between two segments for which the label is absent or off type. These segments thus define several sequences within the signalling events that are received as an input, and these sequences are processed independently of each other. The device 2 may also process them sequentially, in parallel, or with a combination of both.

When the signalling events received as an input do not explicitly contain a location radius, the function Init() can also be arranged to generate this data when possible, or to supply a generic value otherwise. Hereinafter, the location radius will be denoted by the reference dmax. This radius is associated with the antenna density in each geographic zone and makes it possible to define more relevant thresholds, because they are linked with the actual density.

Once the sequences have been determined by the operation 200, the preprocessing unit is arranged to execute a function PreT() in an operation 210. The role of the function PreT() is to pre-segment each sequence into long stops, and to detect stop-movement segments optionally.

FIG. 3 shows an exemplary implementation of the function PreT(). In an operation 300, a function LongS() is executed. The role of the function LongS() is to identify stops in signalling events that have a long duration, i.e. greater than 30 minutes for example.

In order to take account of antenna hopping, this function does not require all signalling events to be associated with the same location, but only that these locations remain sufficiently close to each other. For this purpose, the locations associated with each signalling event are first smoothed by averaging them with the locations of a chosen number of temporally adjacent signalling events. This makes it possible to reduce noise on the locations. Once the locations have been smoothed thus, the function LongS() detects stationary phases, by searching for the periods of maximum duration during which the smoothed location of the mobile communication device remains within a certain radius—based for example on the location radius or on an average of the location radii associated with the signalling events in question, or based on dmax—from a reference point. When the threshold is based on dmax, this makes it possible to detect long stops that are quite close in urban zones, without reducing the quality of long stop detection in rural zone, where very distant antennas would be disadvantageous in the event of a fixed threshold. Alternatively, preliminary smoothing is not applied. Also alternatively, the function LongS() is applied with preliminary smoothing and without prelinary smoothing, and the longest stationary phase is retained.

Each time, the combination of the associated signalling events defines a long stop segment. Hereinafter, these segments will be treated as stop segments, but their description as “long” is important for processing by the processing unit as seen below. Optionally, a final check can be performed to test whether two successive long stop segments close in time can be merged or not, for example based on their respective locations. Otherwise, it is possible to generate a movement segment between these two long stop segments, which will be labelled so that it cannot be modified by any of the subsequent processing.

After the function LongS() is completed, the movement stop segments can be detected in an operation 310 by means of a function StMv(). The function StMv() is, as explained, optional and searches for segments formed by two successive signalling events that are separated by a duration greater than a threshold (for example 15 minutes, or a threshold based on dmax), and for which the locations are at a sufficient distance to be certain that there has been a movement (for example, the distance between their respective locations exceeds 1 km, or a threshold based on dmax), but such that the speed is too low for the entire period to correspond to a movement segment. If these locations are too close, i.e. their distance is less than another threshold, for example 100 m or a threshold based on dmax, the segment is labelled as stop. Finally, the function StMv() tags the segments labelled as stop or stop-movement so that they are not modified by the processing unit.

Once the operation 210 is completed, the signalling events are preprocessed, i.e. they have been grouped, segmented into sequences, and re-segmented into portions between long stops, with detection of stop-movements or stops where applicable.

The processing unit 8 then carries out an operation 220 by executing a function T(). FIG. 4 shows an exemplary implementation of the function T(). From a high-level perspective, the aim of the function T() is that of running through the events not associated with a labelled segment between two long stops, each defining a boundary of a sliding window of fixed size, and by determining for each window a stop type or movement type label according to the signalling events contained in this window. Alternatively, the size may not be perfectly fixed, and the function T() may search for the most relevant point, for example the closest to this fixed size. Once the events not associated with a labelled segment between two long stops have been run through by ascending timestamps and by descending timestamps, the window labels are projected on each segment they contain, and each segment is associated with a label according to this projection. Optionally, the function TO) can be carried out by not labelling any window from a given event of timestamp t if no event is found in a range t+3 minutes and t+30 minutes. This avoids systematically retaining the first point after t+30 minutes, which generates noise.

Thus, in an operation 400, the smoother 12 executes a function EvtLst() that retrieves the list (or a table) of all signalling events between two long stop segments (or an absent or off segment and a long stop segment where applicable), and excludes signalling events that belong to an already labelled segment, whether as movement by the operation 300, or as stop-movement or stop by the operation 310.

Then, two loops are created, each starting from a temporal end of the list obtained from the operation 400, in order to run through the latter in the ascending and descending timestamp direction.

For this purpose, the smoother 12 pops the list in an operation 410 by executing a function Pop+() (respectively in an operation 430 by executing a function Pop−()) that retrieves the signalling event with the immediately ascending (respectively descending) timestamp from the list. If such a signalling event exists, then the smoother 12 executes a function Wind() in an operation 420 (respectively 440), by defining a time window of approximately 15 minutes that comprises the events of the list for which the timestamps are between the timestamp of the event of the operation 410 (respectively the operation 430) and 15 minutes after (respectively 15 minutes before), then compares the distance between the location of the event resulting from the operation 410 (respectively the operation 430) and the location of the temporally most distant signalling event in the window. If the distance between these two locations exceeds a chosen threshold distance (for example, 8 times dmax, or less than 15 times dmax, i.e. about 1 kilometre in an urban zone and about ten kilometres in a rural zone), then the window is associated with a movement label, and otherwise with a stop label.

When all of the signalling events have been run through, the operation 410 and the operation 430 return a negative value, and the compactor 14 is invoked to process the labelled windows and qualify the segments in an operation 450 by executing a function Segm(). In the example described here, the function Segm() runs through each segment defined by a pair of signalling events whose timestamps are consecutive, selects the windows that temporally overlap this segment, and counts the number of stop labels and the number of movement labels. If the number of movement labels exceeds the number of stop labels, then the segment is assigned a movement type label. Otherwise, it is assigned a stop type label.

As an output, all of the segments are therefore labelled, either as absent, or off, or stop (long), or movement (non-modifiable), or stop, or movement. Hereinabove, the list of signalling events is run through in both temporal directions in parallel. Alternatively, it could be run through first in one direction and then in the other. Again alternatively, it could be run through, but only in one direction. Furthermore, the function Segm() may also take into account the timestamps of adjacent segments, so that 15 signalling events in 5 minutes have the same weight as 5 signalling events at the same time.

Once the operation 220 is completed, the post-processing unit 10 reduces the stop and movement segments according to several operations. The Applicant has discovered that the order described here adds a high precision to the trajectory data produced as an output, but that another order already adds great progress compared to prior art methods.

Thus, the post-processing unit 10 executes a function PostT() in an operation 230. FIG. 5 shows an exemplary implementation of the function PostT().

From a high-level perspective, the function PostT() first processes short movement segments, then optionally converts stop-movement segments, then processes short stop segments, then optionally forces all segments to be stop or movement type, before assigning a location to each stop segment.

In an operation 500, the post-processing unit starts by executing a function ShMv(). The function ShMv() runs through all of the movement segments and determines those that have a duration less than a threshold duration, for example 3 minutes, unless this segment was tagged as non-modifiable in the operation 300. All the resulting segments are assigned a stop type label if at least one adjacent segment has a stop type label. Otherwise, and if presence labels are used, then a presence label is assigned. If presence labels are not used, a stop label is assigned in all cases.

Then, in an optional operation 510, the post-processing unit 10 executes a function StMpSplt(). This function runs through all of the stop-movement segments, and converts them if the stop-movement segment is surrounded by a stop segment and a movement segment, regardless of their order. In this case, the stop segment is considered to represent the actual stop, and the movement segment represents the actual movement, and the stop-movement segment is broken down according to the speed observed over the 15 minutes of the movement “attached” to this stop-movement segment and merged accordingly. Thus, the stop segment and the movement segment are extended proportionally by deleting the stop-movement segment, and creating a common time boundary located within the latter.

Then, or when stop-movement labels are not used, short stop segments are processed by a function ShSt() executed by the post-processing unit 10 in an operation 520. Similarly to the operation 510, this function converts short duration stop segments (for example less than 5 minutes), if they are adjacent to a movement segment, into a movement segment by merging with the latter, and into a presence type segment otherwise when the latter are used. Otherwise, they are converted into a movement segment, optionally merged with an adjacent movement segment where applicable.

When it is desired that the trajectory data contain only stop or movement type segments, a function ForceSM() can be executed in an optional operation 530 by the post-processing unit 10. In this function, stop-movement segments that have not been converted by the operation 510 and presence segments can be converted to a stop segment or a movement segment. For example, if an adjacent segment is a stop segment, then the segment is converted to a movement segment. Otherwise, it is converted to a stop segment.

After the operation 520 or the operation 530 where applicable, the segments have been fully post-processed and are ready for use to be returned as trajectory data. In order to refine their locations, each resulting stop segment is run through in an operation 540 by a function Loc() which computes the barycentre of all of the signalling events between the boundaries of these segments. Thus, the location associated with each stop segment is smoothed by all of the signalling events contained therein. The location radius of these events can also be averaged to be associated with these segments. In order to determine an even more precise location, the function Loc() can execute one or more of the following processing operations:
removing “end” points, detected by comparing the movement of the barycentre if the points at the greatest distance from the current barycentre are deleted, and repeating this deletion iteratively, until the movement is no longer significant, or a number of repetitions is reached, and
estimating a “radius” of the stop zone, taking into account both the local dmax and the dispersion of the stop events (for example max (3*dmax, 80% quantile of the distances to the barycentre)), and excluding events that are not within this radius for computing the barycentre.

The same operation can be executed on presence type segments.

Finally, optionally, a segmentation of the stop segments can make it possible to retain, for the stop segments for which the locations are very close, and for example less than a threshold based on their location radius, a single and unique location.

The Applicant has discovered that the operations 200 to 230 make it possible to produce trajectory data for which the accuracy greatly exceeds that of prior art solutions. While working on antenna hopping, it also discovered that it is possible to perform an additional so-called refining operation, which makes it possible to reprocess movement segments in trajectory data, in order to make the trajectory even more accurate.

Thus, the Applicant started from the principle that antenna hopping is a relatively unpredictable type of noise that breaks the “logical” movement chain temporally. In other words, because of antenna hopping, the mobile communication device virtually takes a detour between two locations that are however close, without this being easily detectable. In order to circumvent the problem, the Applicant looked at enhancing signalling data, in order to give itself the option of reconstructing the most probable trajectory. For this purpose, it therefore studied how to add the information to signalling events to recompute a more probable trajectory.

For this purpose, it started from the idea that the sequence of signalling events can be viewed as a “poor” graph that links signalling events two by two in a temporally ascending manner (i.e. one graph or each vertex with a single upstream and downstream neighbour at most). As this graph is undetectably noisy, it sought to enhance it by generating “probable”links between temporally close signalling events.

Thus, the device 2 is arranged to execute a function Ref() in an operation 240 in order to carry out this enhancement. FIG. 6 shows an exemplary implementation of the function Ref() by the post-processing unit 10.

In an operation 600, a function SMSLst() is executed that runs through trajectory data and segments it into sequences for which the ends are stop segments and which comprise at least one movement segment between them. Each sequence initialises a graph in the form of a line that links the signalling events within each segment of the sequence two to two, by ascending timestamps. The sequences are then run through separately, as after the operation 200.

Each sequence is passed through in order to enhance, step by step, the graph representing the possible paths between signalling events in a loop. For this purpose, the sequence is popped from a current signalling event in an operation 610, then a function Graph() is executed in an operation 620. The function Graph() uses the current signalling event and enhances the graph by linking together in the graph all of the signalling events whose timestamp is in a chosen duration window (for example 5 minutes, or a value based on the value dmax) centred on the current signalling event. Optionally, before linking two signalling events in the graph, the function Graph() can check that their locations do not have a distance exceeding a chosen threshold between them. This avoids overloading the graph unnecessarily and prevents excessively large “jumps” in the trajectory, particularly for movements at very high speed.

Optionally, if the operation 620 does not add any link to the graph, a function Add() can be executed in an operation 630. The function Add() can select signalling events before the current signalling event of a chosen time threshold (for example 1 minute), and also signalling events after the signalling event immediately following the current signalling event of the same chosen time threshold, and link them all together. This advantageously makes it possible, when two consecutive events are separated by a time greater than the chosen threshold, to enable the shortest path retained not to pass through these two points. The reason is that without this processing, this pair of events becomes the only “bridge” in the graph connecting the points before the first to the points after the second. Therefore, if one of the two events has a very noisy location, a potentially “incorrect” point would be retained.

Then, the loop is repeated with the operation 610, until the sequence has been run through completely. A function ShtRt() is then executed in an operation 640 to determine the shortest path within the enhanced graph. This function determines the shortest path within the enhanced graph, the weight function being defined by the distance between the respective locations of two linked signalling events in the graph. This results in trajectory data that smooths the route geographically along the shortest probable trajectory by virtue of its component signalling events.

Finally, a function RdfMSeg() is executed in an operation 650 in order to recompose the segments from the new sequence of signalling events that has been determined, then the function Ref() ends in an operation 699.

It should be noted that, in order to ensure continuity of trajectory data locations, if a movement segment to be simplified is adjacent to at least one stop segment, the start and/or end point of the movement segment is constrained to be located at the location of the stop segment in question. In the case of a transition between a stop segment and a movement segment located at a time not corresponding to a signalling event, an imaginary signalling event is generated by taking the location of the stop segment and the timestamp of the movement segment.

The operation 240 is optional, and the operations 200 to 230 can be executed independently thereof. Similarly, the operation 240 is independent of the operations 200 to 230, once the corresponding trajectory data and signalling events are accessible. The Applicant thus discovered to its great surprise that the operation 240 is fully compatible with the trajectory data determined by means of the methods described in the European patent published under number EP 3 329 696 and the patent application published under number EP 3 586 319.

In the foregoing, GNSS or GPS type data can also be used, alternatively to mobile phone data. The idea is as follows: if GNSS or GPS data is available, it will be used first. When this data is not available, the mobile phone data processed by the invention is used. In this case, the GNSS or GPS data can be processed according to the invention, with a distance dmax of about 10 metres for example, and with an event absence duration to arrive at a short “Absent” segment (for example 30 minutes).

1. A device for determining a trajectory comprising:
a memory arranged to receive mobile or wireless telephone network signalling events each comprising a mobile communication device identifier, a timestamp and a signalling identifier associated with a location and with a location radius,
a preprocessing unit arranged, for a given mobile communication device identifier, to run through the associated signalling events, and to identify one or more long stationary state groups comprising signalling events such that, within a given long stationary state group, the timestamps are consecutive and define a range whose duration is greater than a first threshold duration, and the locations have a distance between them less than a first threshold distance based on one or more of the location radii,
the preprocessing unit being arranged to define a long stationary state segment from each long stationary state group, each long stationary state segment comprising on one hand boundaries corresponding to the end timestamps of the long stationary state group from which it originates and on the other a location determined from the locations of the signalling events of the long stationary state group from which it originates, and being associated with a stop type label,
a processing unit, arranged to process the signalling events whose timestamps are located outside a long stationary state segment by pair of signalling events having immediately consecutive timestamps that define the boundaries of a trajectory segment, comprising
a smoother arranged to run through the signalling events whose timestamps are located outside a long stationary state group first by ascending or descending timestamps, then by descending or ascending timestamps, to define during these two runs, for each current signalling event, a time window of which one end corresponds to said current signalling event, and the other end is a signalling event chosen in the ascending or descending run direction and for which the timestamp defines with the timestamp of the current signalling event a duration substantially equal to a second threshold duration, and to associate with each window a label belonging to a group comprising a movement and a stop, according to the distance between the locations of the signalling events defining its boundaries,
a concentrator arranged, once the smoother has processed all of the signalling events whose timestamps are located outside a stationary state group have been run through by ascending and descending timestamps, to associate with each trajectory segment a label determined according to the labels of the time windows overlapping the boundaries of this trajectory segment, and a post-processing unit (10) arranged to:
first run through the trajectory segments associated with a movement type label, and change the label of some of these trajectory segments when the duration between its boundaries is less than a third threshold duration,
then run through the trajectory segments associated with a stop type label, and change the label of some of these trajectory segments when the duration between its boundaries is less than a fourth threshold duration,
determine for each trajectory segment associated with a stop type label a location determined from the locations of the signalling events whose timestamps are between the timestamps of its boundaries, and
return the long stationary state segments and the trajectory segments as trajectory data.

2. The device according to claim 1, wherein the processing unit is arranged, before applying the smoother,
to associate, with each trajectory segment for which the locations of its component signalling events have between them a distance which exceeds a second threshold distance and which, relative to the duration between the timestamps of said component signalling events, is less than a first threshold speed, a stop-movement type label,
to associate, with each trajectory segment for which the locations of its component signalling events have between them a distance which is less than a third threshold distance, a stop type label, and
to exclude from processing by the smoother the signalling events whose timestamp is within a trajectory segment associated with a stop-movement type label or a stop type label.

3. The device according to claim 2, wherein the post-processing unit is arranged, after running through the trajectory segments associated with a movement type label, and before running through the trajectory segments associated with a stop type label, to run through the trajectory segments associated with a stop-movement type label, and, for such a given trajectory segment, if the given trajectory segment is surrounded by two trajectory segments, one of which is associated with a stop type label and the other with a movement type label, to determine a distribution timestamp among the timestamps of the signalling events whose timestamps are between the timestamps of its boundaries according to the speed observed on the events of the segment associated with a movement type label that are closest to the given trajectory segment, and to redefine, on one hand, the trajectory segment associated with a stop type label so that it incorporates the events of the given trajectory segment for which the timestamps are closest to it up to the distribution timestamp and, on the other, the trajectory segment associated with a movement type label so that it incorporates the events of the given trajectory segment for which the timestamps are closest to it up to the distribution timestamp.

4. The device according to claim 3, wherein the post-processing unit is arranged, after running through the trajectory segments associated with a stop type label, to run through the trajectory segments associated with a stop-movement type label, and to associate a stop type label or a movement type label with them.

5. The device according to one of the preceding claims, wherein the post-processing unit is arranged, during the run through the trajectory segments associated with a movement type label, to change the label of a trajectory segment whose duration between its boundaries is less than a third threshold duration into a stop type label when an immediately adjacent trajectory segment is associated with a stop type label, and into a presence type label otherwise.

6. The device according to claim 1, wherein the post-processing unit is arranged, during the run through the trajectory segments associated with a stop type label, to change the label of a trajectory segment whose duration between its boundaries is less than a fifth threshold duration into a movement type label when an immediately adjacent trajectory segment is associated with a stop type label, and into a presence type label otherwise.

7. A method for determining a trajectory comprising the following operations:
a) receiving mobile or wireless telephone network signalling events each comprising a mobile communication device identifier, a timestamp and a signalling identifier associated with a location and with a location radius,
b) for a given mobile communication device identifier, running through the associated signalling events, and identifying one or more long stationary state groups comprising signalling events such that, within a given long stationary state group, the timestamps are consecutive and define a range whose duration is greater than a first threshold duration, and the locations have between them a distance less than a first threshold distance taken from one or more of the location radii,
c) defining a long stationary state segment from each long stationary state group, each long stationary state segment comprising on one hand the boundaries corresponding to the end timestamps of the long stationary state group from which it originates and on the other a location determined from the locations of the signalling events of the long stationary state group from which it originates, and being associated with a stop type label,
d) processing the signalling events whose timestamps are located outside a long stationary state segment by pair of signalling events having immediately consecutive timestamps that define the boundaries of a trajectory segment,
e) running through the signalling events whose timestamps are located outside a long stationary state group first by ascending or descending timestamps, then by descending or ascending timestamps, to define during these two runs, for each current signalling event, a time window of which one end corresponds to said current signalling event, and the other end is a signalling event chosen in the ascending or descending run direction and for which the timestamp defines with the timestamp of the current signalling event a duration substantially equal to a second threshold duration, and to associate with each window a label belonging to a group comprising a movement and a stop, according to the distance between the locations of the signalling events defining its boundaries,
f) after operation e) has processed all of the signalling events whose timestamps are located outside a stationary state group have been run through by ascending and descending timestamps, to associate each trajectory segment with a label determined according to the labels of the time windows which overlap the boundaries of this trajectory segment, and
g1) first running through the trajectory segments associated with a movement type label, and changing the label of some of at least these trajectory segments when the duration between its boundaries is less than a third threshold duration,
g2) then running through the trajectory segments associated with a stop type label, and changing the label of some of at least these trajectory segments when the duration between its boundaries is less than a fourth threshold duration,
g3) determining for each trajectory segment associated with a stop type label a location determined from the locations of the signalling events whose timestamps are between the timestamps of its boundaries, and
g4) returning the long stationary state segments and the trajectory segments as trajectory data.

8. The method according to claim 7, wherein operation e) comprises the following preliminary operations:
e1) associating, with each trajectory segment for which the locations of its component signalling events have between them a distance which exceeds a second threshold distance and which, relative to the duration between the timestamps of said component signalling events, is less than a first threshold speed, a stop-movement type label,
e2) associating, with each trajectory segment for which the locations of its component signalling events have between them a distance which is less than a third threshold distance, a stop type label, and
e3) excluding from the processing of operation e) the signalling events whose timestamp is within a trajectory segment associated with a stop-movement type label or a stop type label.

9. The method according to claim 8, comprising, after operation g1) and before operation g2, operation g1a) of running through the trajectory segments associated with a stop type label, and, for such a given trajectory segment, if the given trajectory segment is surrounded by two trajectory segments, one of which is associated with a stop type label and the other with a movement type label, determining a distribution timestamp among the timestamps of the signalling events whose timestamps are between the timestamps of its boundaries according to the speed observed on the events of the segment associated with a movement type label that are closest to the given trajectory segment, and redefining, on one hand, the trajectory segment associated with a stop type label so that it incorporates the events of the given trajectory segment for which the timestamps are closest to it up to the distribution timestamp and, on the other, the trajectory segment associated with a movement type label so that it incorporates the events of the given trajectory segment for which the timestamps are closest to it up to the distribution timestamp.

10. The method according to claim 9, comprising, after operation g2), operation g2a) of running through the trajectory segments associated with a stop-movement type label, and associating them with a stop type label or a movement type label.

11. The method according to claim 7, wherein operation g1) comprises changing the label of a trajectory segment whose duration between its boundaries is less than a third threshold duration into a stop type label when an immediately adjacent trajectory segment is associated with a stop type label, and into a presence type label otherwise.

12. The method according to claim 7, wherein operation g2) comprises changing the label of a trajectory segment whose duration between its boundaries is less than a fifth threshold duration into a movement type label when an immediately adjacent trajectory segment is associated with a movement type label, and into a presence type label otherwise.

13. A computer program comprising instructions to execute the method according to claim 7 when executed by a computer.

14. A data storage medium having the computer program according to claim 13 recorded thereon.
